(19) United States
(12) Patent Application Publication
(10) Pub. No.: US 2023/0294878 A1
(43) Pub. Date: Sep. 21, 2023

(54) SYSTEM AND METHOD TO MAP AND ASSIGN DRINKS OR LIQUID CONTAINERS TO SPECIFIC USERS

(71) Applicant: 2Design It LLC, Calimesa, CA (US)

(72) Inventor: Donna Carr, Carlsbad, CA (US)

(21) Appl. No.: 17/992,650

(22) Filed: Nov. 22, 2022

Related U.S. Application Data
(60) Provisional application No. 63/320,398, filed on Mar. 16, 2022.

(51) Int. Cl. B65D 23/14; B65C 3/08

(52) U.S. Cl. CPC B65D 23/14; B65C 3/08

(57) ABSTRACT

A system and method for assigning liquid containers to specific users are disclosed. In one embodiment, the method includes affixing a plurality of identifying labels to a plurality of liquid containers belonging to a plurality of users. The method further includes assigning the plurality of identifying labels to the plurality of users, wherein each of the plurality of identifying labels has a unique artistic symbol or graphic icon, the unique artistic symbol or graphic icon is assigned to a specific user selected from the plurality of users, and the specific user uses the unique artistic symbol or graphic icon to identify his or her liquid container.

### CROSS-REFERENCE TO RELATED APPLICATIONS

The present Application claims the benefit of U.S. Provisional Patent Application Ser. No. 63/320,398 filed on Mar. 16, 2022, the entire disclosure of which is incorporated herein in its entirety by reference.

### FIELD

The present invention relates to a system and method to map and assign drinks or liquid containers to specific users.

### BRIEF DESCRIPTION OF THE DRAWINGS

FIGS. 1A and 1B illustrate exemplary stickers with unique artistic symbols or graphic cons according to one embodiment.

FIGS. 2A-2D illustrate alternative exemplary embodiments where the stickers shown in FIGS. 1A and 1B are affixed to different “Tag it” labels.

FIG. 3 shows a “Tag it” label with an affixed sticker attached to a water bottle according to an exemplary embodiment.

FIGS. 4A and 4B illustrate a user in scenarios where water bottles are and are not tagged according to an exemplary embodiment.

FIG. 5 shows a ledger used to keep track of the one-to-one mapping of “Tag it” labels to users according of an exemplary embodiment.

FIGS. 6A and 6B illustrate alternative exemplary embodiments of “Tag it” labels.

FIG. 7 shows a “Tag it” label (shown in FIGS. 6A and 6B) attached to a water bottle according to an exemplary embodiment.

FIG. 8 shows a ledger used to keep track of the one-to-one mapping of “Tag it” labels (shown in FIGS. 6A and 6B) to users according of an exemplary embodiment.

### SUMMARY

A system and method for assigning liquid containers to specific users are disclosed. In one embodiment, the method includes affixing a plurality of identifying labels to a plurality of liquid containers belonging to a plurality of users. The method further includes assigning the plurality of identifying labels to the plurality of users, wherein each of the plurality of identifying labels has a unique artistic symbol or graphic icon, the unique artistic symbol or graphic icon is assigned to a specific user selected from the plurality of users, and the specific user uses the unique artistic symbol or graphic icon to identify his or her liquid container.

### DESCRIPTION

Plastic waste has been and still is a huge problem. As an example, it is estimated that each person uses up to over 150 water bottles per year, resulting in billions of plastic water bottles used each year. It is a known fact in every household in the U.S. that water bottles are left to trash because people do not know which one is theirs. Everyday people trash half used water bottles because they do not remember which water bottle belongs to them. There are about 900 billion water bottles produced annually. If even one ounce of water could be saved from one person of these bottles, it would save about 266 million liters of wasted drinking water. Furthermore, people pick up the wrong water bottle and spread germs. If there exists a system and method to assist users to identify their respective water bottles, such system and method would help reduce plastic and water waste, as well as reducing the potential spread of germs.

In general, the inventive system and method includes a sticker that could be attached or adhered to a drink or a liquid container (such as a water bottle, a cup of tea or coffee, etc.). In one embodiment, the sticker could be waterproof. Furthermore, each sticker could include a unique artistic symbol or a graphic icon. Once a person or user attaches or adheres the sticker to his or her drink, a water bottle, or a liquid container, a person or user could use the unique artistic symbol or graphic icon on the sticker to identify his or her drink, water bottle, or liquid container.

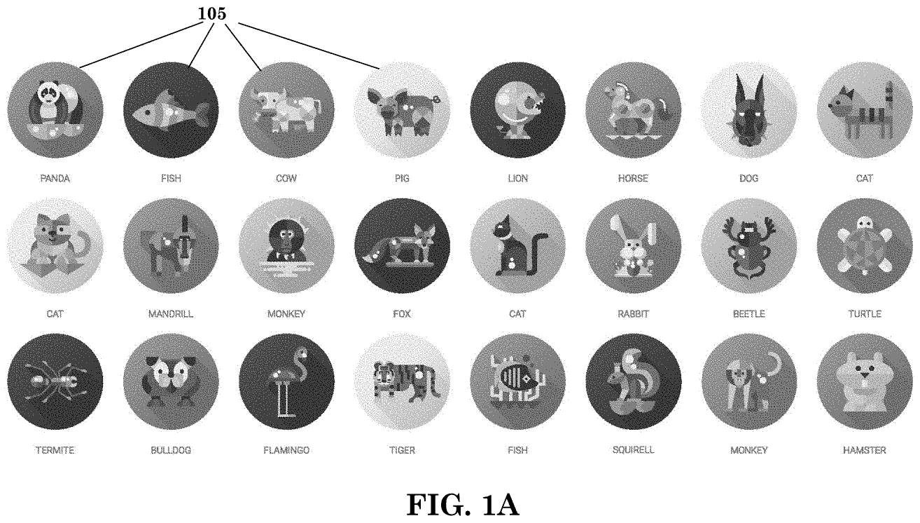

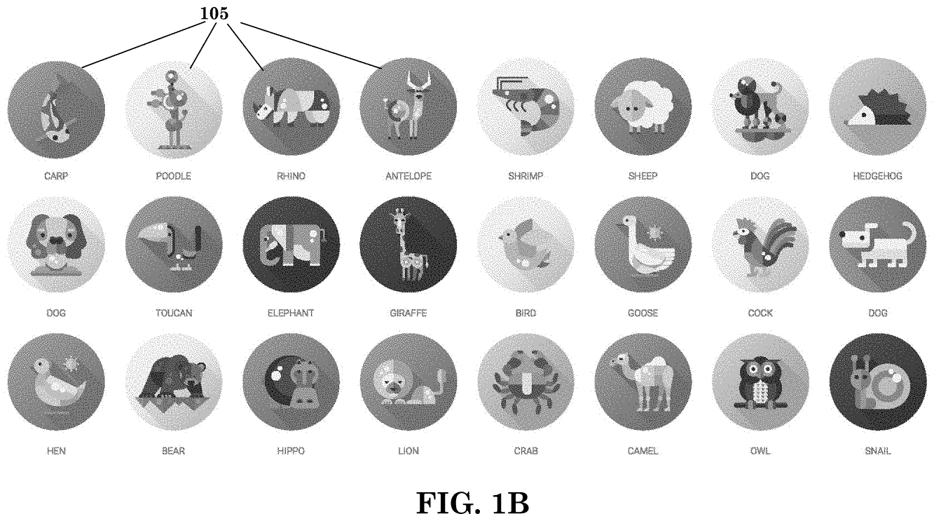

FIGS. 1A and 1B illustrate exemplary stickers with unique artistic symbols or graphic cons according to one embodiment. As shown in FIGS. 1A and 1B, each sticker includes a different and unique artistic or graphic representation of an animal. In practice, the sticker may include any unique artistic symbols or any graphic icons. The unique artistic symbols or graphic icons could be provided by a provider, or could be designed and made by the users.

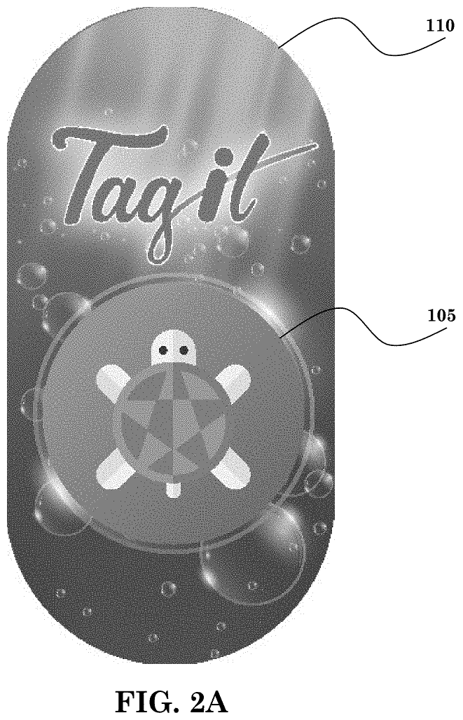

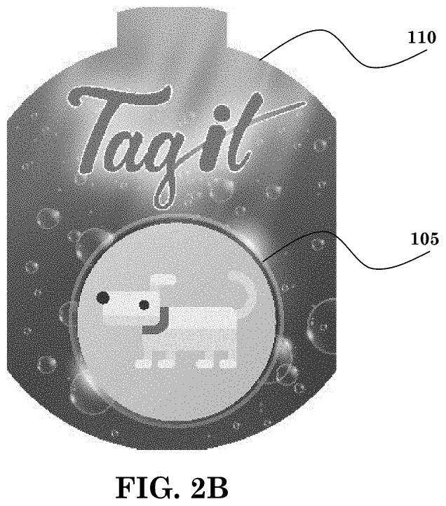

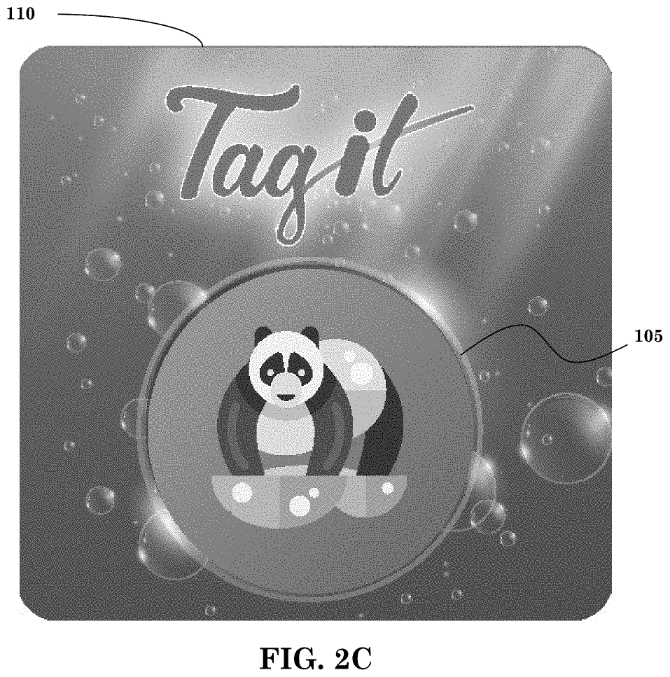

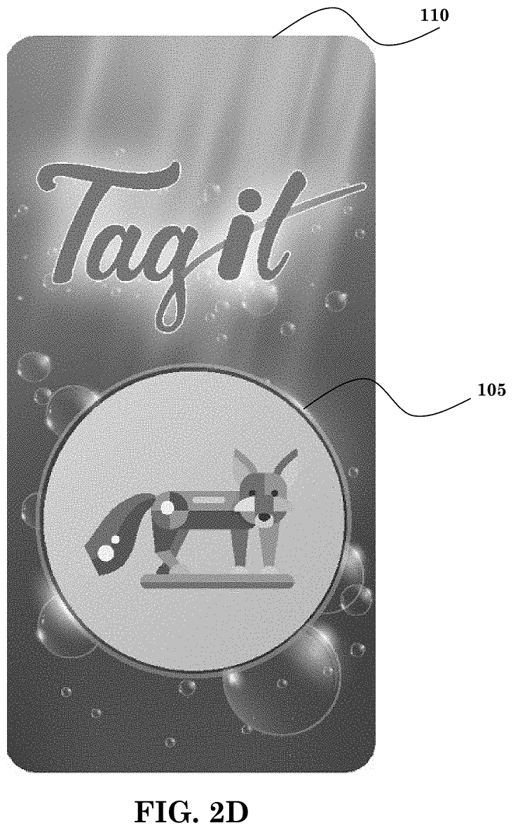

FIGS. 2A-2D illustrate alternative exemplary embodiments where the stickers 105 shown in FIGS. 1A and 1B are affixed to different “Tag it” labels (shown as element 110 on FIGS. 2A-2D). The “Tag it” label could generally be used as an identifying label that helps a person or user to identify his or her liquid container, cup, or water bottle. In one embodiment, the “Tag it” labels could be adhesive labels. As shown in FIGS. 2A-2D, the “Tag it” label 110 could come in different sizes and shapes. In particular, the “Tag it” label 110 shown in FIG. 2A is a bottle tag. The “Tag it” labels 110 shown in FIGS. 2B, 2C, and 2D are round beverage tags, square beverage tags, and tall beverage tags respectively. Each “Tag it” label 110 shown in FIGS. 2A-2D could be affixed with a different sticker 105 with a different and unique artistic symbol or graphic icon.

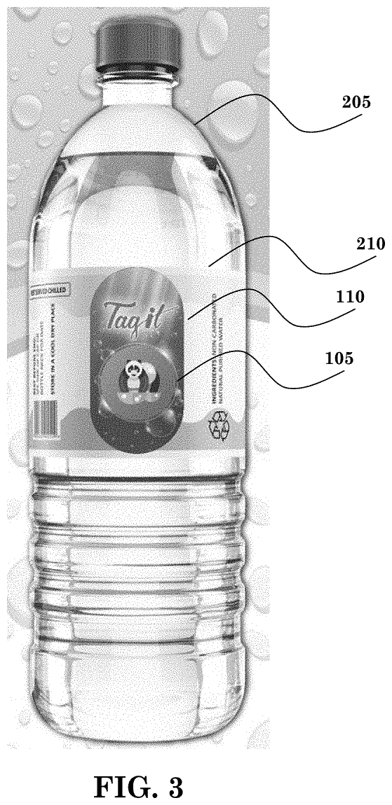

FIG. 3 shows a “Tag it” label 110 with an affixed sticker 105 attached to a water bottle 205 according to an exemplary embodiment. As shown in FIG. 3, the “Tag it” label 110 is attached to the water bottle label 210. In one embodiment, the “Tag it” label 110 and/or the artistic symbol or graphic icon 105 on the “Tag it” label 110 could be printed directly on the water bottle label 210.

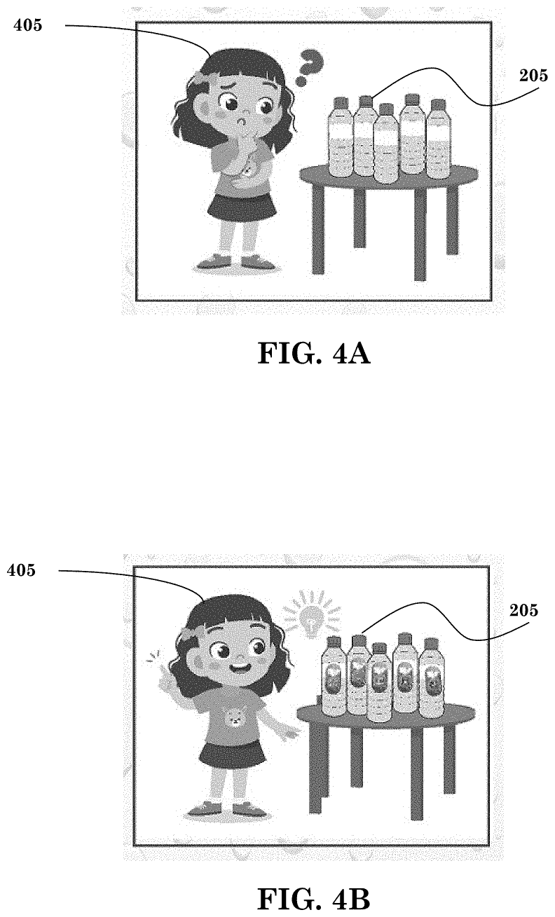

As discussed above, once a person or user 405 attaches or adheres the “Tag it” label 110 to his or her water bottle 205 (or to a drink or a liquid container), the person or user 405 could use the unique artistic symbol or graphic icon on the sticker to identify his or her water bottle 205 (or his or her drink or liquid container), as illustrated in FIGS. 4A and 4B. More specifically, FIG. 4A illustrates a scenario where a user 405 is confused and does not know which water bottle 205 on a table belongs to her as the water bottles are untagged and unidentifiable. In contrast, FIG. 4B illustrates a scenario where water bottles on the table are tagged with “Tag it” labels with different affixed stickers. As shown in FIG. 4B, the unique artistic symbol or graphic icon on the affixed sticker enables the user to identify which water bottle 205 is hers.

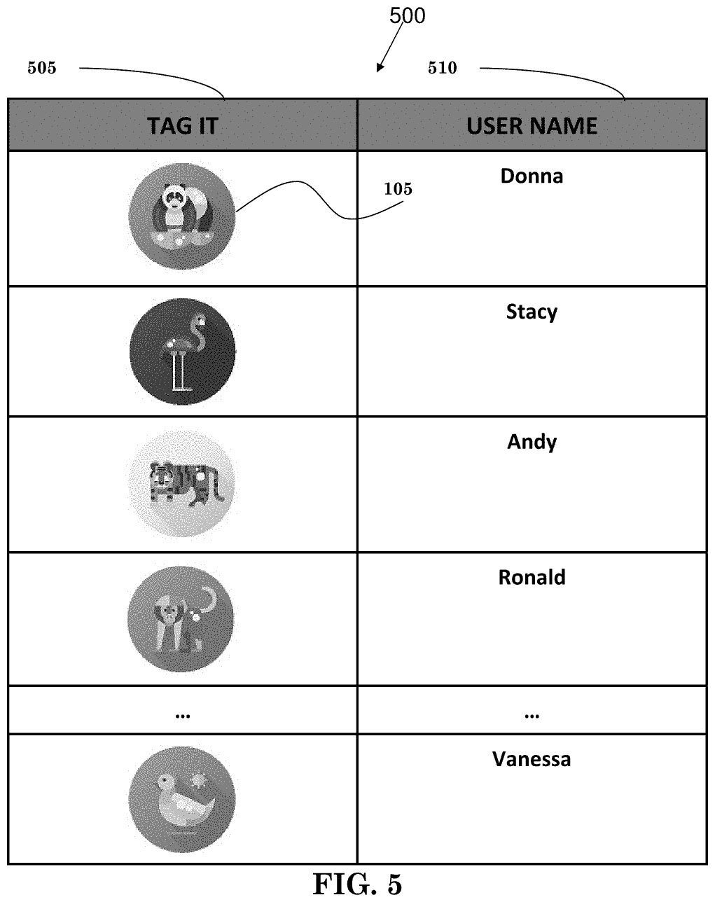

FIG. 5 illustrates a ledger 500 that could be used to keep track of the one-to-one mapping of the stickers and the users according to one exemplary embodiment. As shown in FIG. 5, the ledger includes a “TAG IT” column 505 on the left and the “USER NAME” column 510 on the right. Unique stickers with unique artistic symbols or graphic icons could be added to the left or “TAG IT” column 505. Each sticker could then be mapped to a corresponding user, whose name could be entered in the right or “USER NAME” column 510. The ledger could then be used to keep track of the one-to-one mapping of “Tag it” labels 105 to users.

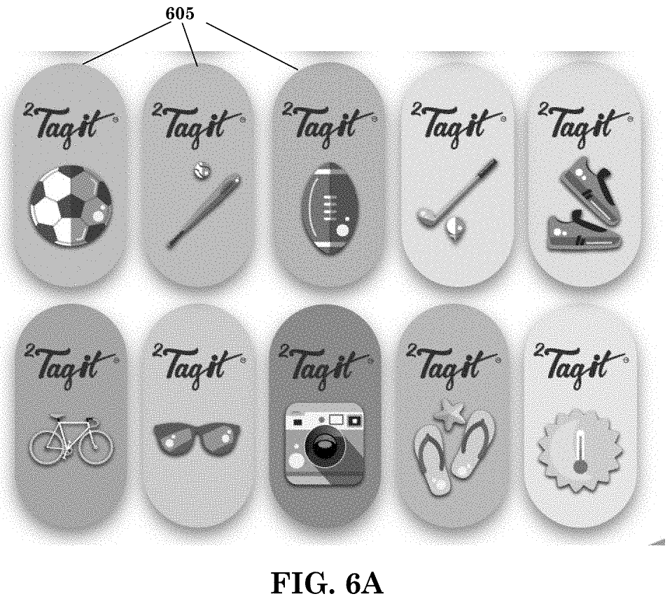

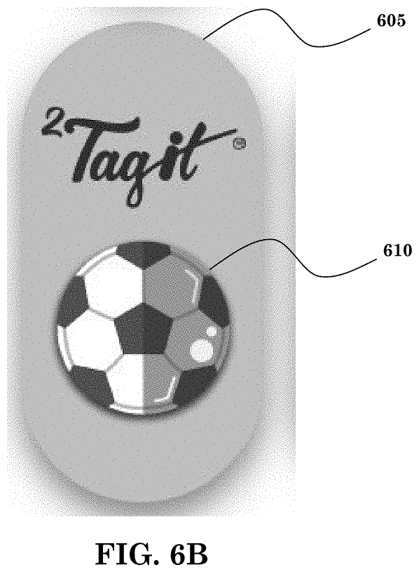

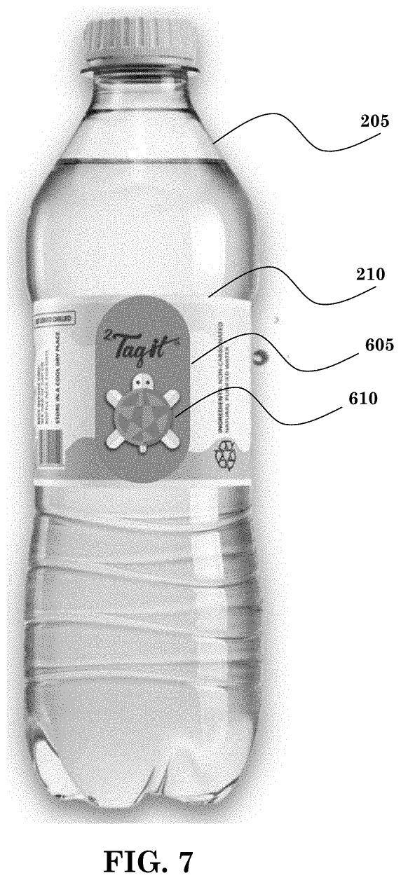

FIGS. 6A and 6B illustrate alternative exemplary embodiments where the artistic symbol or graphic icon 610 is printed directly on the “Tag it” label 605. Each “Tag it” label 605 shown in FIGS. 6A and 6B could have a different and unique artistic symbol or graphic icon. 610. FIG. 7 shows a “Tag it” label 605 with an artistic symbol or graphic icon 610 attached to a water bottle 205 according to an exemplary embodiment. As shown in FIG. 7, the “Tag it” label 605 is attached to the water bottle label 210. In one embodiment, the “Tag it” label 605 and/or the artistic symbol or graphic icon 610 could be printed directly on the water bottle label 210.

As discussed above, once a person or user attaches or adheres the “Tag it” label to his or her water bottle 205 (or to a drink or a liquid container), the person or user could use the unique artistic symbol or graphic icon on the sticker to identify his or her water bottle (or his or her drink or liquid container).

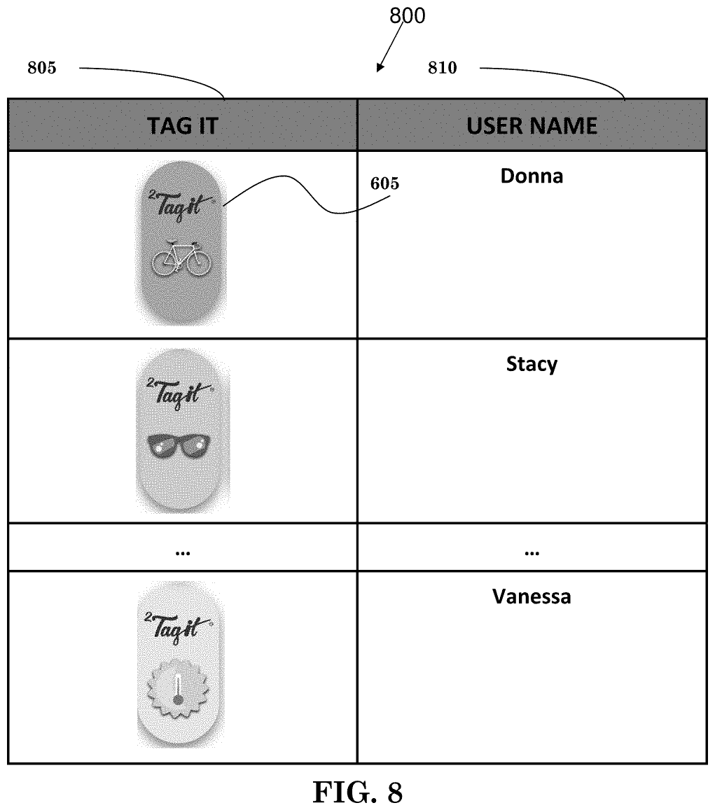

FIG. 8 illustrates a ledger 800 used with the “Tag it” labels 605 to keep track of the one-to-one mapping of the labels and the users according to one exemplary embodiment. As shown in FIG. 8, the ledger includes a “TAG IT” column 805 on the left and the “USER NAME” column 810 on the right. “Tag it” labels 605 with different artistic symbols or graphic icons could be added to the left or “TAG IT” column 805. Each sticker could then be mapped to a corresponding user, whose name could be entered in the right or “USER NAME” column 810. The ledger could then be used to keep track of the one-to-one mapping of “Tag it” labels 605 to users.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for assigning liquid containers to specific users, comprising:
affixing a plurality of identifying labels to a plurality of liquid containers belonging to a plurality of users; and
assigning the plurality of identifying labels to the plurality of users, wherein each of the plurality of identifying labels has a unique artistic symbol or graphic icon, the unique artistic symbol or graphic icon is assigned to a specific user selected from the plurality of users, and the specific user uses the unique artistic symbol or graphic icon to identify his or her liquid container.

2. The method of claim 1, wherein the unique artistic symbol or graphic icon is printed on the identifying label.

3. The method of claim 1, wherein the unique artistic symbol or graphic icon is a sticker affixed on the identifying label.

4. The method of claim 1, wherein the liquid container is a water bottle with a water bottle label, and the identifying label is an adhesive label that is affixed to the water bottle label.

5. The method of claim 1, wherein the liquid container is a water bottle with a water bottle label, and the identifying label is printed on the water bottle label.

6. The method of claim 1, further comprising:
generating a ledger and recording in the ledger information relating to the assigning of the plurality of identifying labels to the plurality of users.

7. A system for assigning liquid containers to specific users, comprising:
a plurality of liquid containers belonging to a plurality of users; and
a plurality of identifying labels affixed to the plurality of liquid containers, wherein each of the plurality of identifying labels has a unique artistic symbol or graphic icon, the unique artistic symbol or graphic icon is assigned to a specific user selected from the plurality of users, and the specific user uses the unique artistic symbol or graphic icon to identify his or her liquid container.

8. The system of claim 7, wherein the unique artistic symbol or graphic icon is printed on the identifying label.

9. The system of claim 7, wherein the unique artistic symbol or graphic icon is a sticker affixed on the identifying label.

10. The system of claim 7, wherein the liquid container is a water bottle with a water bottle label, and the identifying label is an adhesive label that is affixed to the water bottle label.

11. The system of claim 7, wherein the liquid container is a water bottle with a water bottle label, and the identifying label is printed on the water bottle label.

12. The system of claim 7, further comprising:
a ledger containing information relating to assignment of the plurality of identifying labels to the plurality of users.
